(19) United States
(12) Patent Application Publication
(10) Pub. No.: US 2012/0278749 A1
(43) Pub. Date: Nov. 1, 2012

(54) METHOD AND APPARATUS FOR PROVIDING CONSUMPTION INFORMATION FOR SOFTWARE APPLICATIONS

(75) Inventors: Pekka Pääkönen, Oulu (FI); Ville Könönen, Oulu (FI); Jussi Liikka, Oulu (FI); Matti Mäki, Lumijoki (FI)

(73) Assignee: Nokia Corporation

(21) Appl. No.: 13/095,078

(22) Filed: Apr. 27, 2011

(51) Int. Cl. G06F 3/048

(52) U.S. Cl. 715/772

(57) ABSTRACT

A method and apparatus are disclosed for providing consumption information for respective ones of a plurality of software applications that are offered to consumers, such as from an application store or a social networking site. One method includes causing a plurality of software applications to be offered to consumers and causing consumption information for respective ones of the plurality of software applications to be retrieved. The consumption information may include information regarding at least one energy-related parameter. The method may also cause generation of a graphical representation of the consumption information for the respective software applications. Another method includes receiving consumption information from a plurality of users for respective ones of a plurality of software applications, determining aggregated consumption information relating to use of the respective software applications by the plurality of users and causing the aggregated consumption information for the respective software applications to be provided.

### TECHNOLOGICAL FIELD

Some example embodiments of the present invention relate generally to energy management and, more particularly, relate to the provision of consumption information regarding respective ones of a plurality of software applications.

### BACKGROUND

Mobile terminals, such as mobile telephones, mobile computers, portable digital assistants (PDAs), pagers, laptop computers, gaming devices and other types of mobile electronic systems, may execute a variety of software applications. These applications may be downloaded to the mobile terminal from a variety of sources. For example, application stores have been developed that offer a plurality of different software applications that a consumer may license.

Mobile terminals are generally supplied power from a battery such that execution of the software applications draws power from the battery. While a mobile terminal may be recharged from time to time, a user may be interested in the remaining lifetime of the battery, particularly in an instance in which the user is unable to currently recharge the battery. In this regard, the rate at which a battery is discharged depends, at least in part, upon the particular software application(s) being executed by the mobile terminal since the energy consumption of various software applications may vary dramatically. Indeed, some software applications may consume significantly more energy and therefore more quickly dissipate the battery than other software applications.

In many instances, however, a user is unaware of the energy consumed by a software application. As such, battery monitoring applications have been introduced that may display the remaining energy in the battery. The battery monitoring applications may map the remaining energy in the battery to usage time estimates for different applications, such as voice calls, music playback, web browsing, etc. As such, a user can quickly determine that a battery with a predefined percentage of its original charge which may correlate to X minutes of voice calls, Y minutes of music playback, or Z minutes of internet browsing. As such, users may adapt their behavior based upon the energy consumption of the various software applications, at least until the battery of the mobile terminal is able to be recharged.

### BRIEF SUMMARY

A method and apparatus are therefore provided according to some embodiments of the present invention for providing consumption information for respective ones of a plurality of software applications that are offered to consumers, such as for license from an application store. As such, the method and apparatus of the example embodiments may permit a consumer to consider the consumption information prior to licensing and downloading of a software application, such as from an application store. A method and apparatus of other example embodiments are provided for determining aggregated consumption information relating to the use of respective ones of a plurality of software applications by a plurality of users. Thus, the method and apparatus of these example embodiments may provide more fulsome consumption information based upon the aggregation of consumption information from the plurality of users.

In one embodiment, a method is provided that includes causing a plurality of software applications to be offered to consumers and causing consumption information for respective ones of the plurality of software applications to be retrieved. In this regard, the consumption information may include information regarding at least one energy-related parameter. The method of this embodiment may also cause generation, with a processor, of a graphical representation of the consumption information for the respective software applications.

The method may also receive an identification of a user. In this embodiment, the method may cause consumption information to be retrieved by causing personal consumption information relating to use of the respective software applications by the user to be retrieved. The method of another embodiment may cause consumption information to be retrieved by causing aggregated consumption information relating to use of the respective software applications by a plurality of users to be retrieved. In one embodiment, the method may cause consumption information to be retrieved by receiving the consumption information through an application programming interface (API) and may also cause generation of the graphical representation of the consumption information by rendering the consumption information on a graphical user interface. In this regard, receiving the consumption information may include receiving a plurality of database records through the API, and rendering the consumption information may include rendering the consumption information according to content within the database records.

In another embodiment, an apparatus is provided that includes at least one processor and at least one memory including computer program code with the at least one memory and the computer program code configured to, with the at least one processor, cause the apparatus to at least cause a plurality of software applications to be offered to consumers and cause consumption information for respective ones of the plurality of software applications to be retrieved. The consumption information may include information regarding at least one energy-related parameter. The at least one memory and the computer program code may also be configured to cause the apparatus to cause generation of a graphical representation of the consumption information for the respective software applications.

The at least one memory and the computer program code of one embodiment are further configured to, with the at least one processor, cause the apparatus to receive an identification of a user and to cause the apparatus to cause consumption information to be retrieved by causing personal consumption information relating to use of the respective software applications by the user to be retrieved. In another embodiment, the at least one memory and the computer program code are configured to, with the at least one processor, cause the apparatus to cause consumption information to be retrieved by causing aggregated consumption information relating to use of the respective software applications by a plurality of users to be retrieved.

The at least one memory and the computer program code may be configured to, with the at least one processor, cause the apparatus to cause consumption information to be retrieved by receiving the consumption information through an application programming interface (API), and to cause generation of the graphical representation of the consumption information by rendering the consumption information on a graphical user interface. In one embodiment, the consumption information includes a plurality of database records that are received through the API, and the consumption information is rendered according to content within the database records.

In a further embodiment, an apparatus is provided that includes means for causing a plurality of software applications to be offered to consumers and means for causing consumption information for respective ones of the plurality of software applications to be retrieved. In this regard, the consumption information may include information regarding at least one energy-related parameter. The apparatus of this embodiment may also include means for causing generation of a graphical representation of the consumption information for the respective software applications.

In one embodiment, a method is provided that includes receiving consumption information from a plurality of users for respective ones of a plurality of software applications. The consumption information of this embodiment includes information regarding at least one energy-related parameter. The method of this embodiment also determines, with a processor, aggregated consumption information, such as at least one of average consumption values or median consumption values, relating to use of the respective software applications by the plurality of users and causes the aggregated consumption information for the respective software applications to be provided.

The method of one embodiment may receive a request for the aggregated consumption information through an application programming interface (API) and may cause the aggregated consumption information to be provided by causing the aggregated consumption information to be provided in response to the request. In another embodiment, the method may also receive an identification of a user in association with the consumption information from the respective user, determine personal consumption information relating to use of the respective software applications by the user and cause the personal consumption information for the respective software applications to be provided. The method of this embodiment may further include receiving a request (including the identification of the user) for the personal consumption information through an application programming interface (API) and causing the personal consumption information to be provided by causing the personal consumption information to be provided in response to the request.

In another embodiment, an apparatus is provided that includes at least one processor and at least one memory including computer program code with the at least one memory and the computer program code configured to, with the at least one processor, cause the apparatus to at least receive consumption information from a plurality of users for respective ones of a plurality of software applications. In this regard, the consumption information may include information regarding at least one energy-related parameter. The at least one memory and the computer program code may also be configured to, with the at least one processor, cause the apparatus to determine aggregated consumption information, such as at least one of average consumption values or median consumption values, relating to use of the respective software applications by the plurality of users and cause the aggregated consumption information for the respective software applications to be provided.

The at least one memory and the computer program code may be further configured to, with the at least one processor, cause the apparatus to receive a request for the aggregated consumption information through an application programming interface (API) and to cause the aggregated consumption information to be provided by causing the aggregated consumption information to be provided in response to the request. In one embodiment, the at least one memory and the computer program code may also be configured to, with the at least one processor, cause the apparatus to receive an identification of a user in association with the consumption information from the respective user, determine personal consumption information relating to use of the respective software applications by the user and cause the personal consumption information for the respective software applications to be provided. In this embodiment, the at least one memory and the computer program code may be further configured to, with the at least one processor, cause the apparatus to receive a request (including the identification of the user) for the personal consumption information through an application programming interface (API) and to cause the personal consumption information to be provided in response to the request.

In a further embodiment, an apparatus is provided that includes means for receiving consumption information from a plurality of users for respective ones of a plurality of software applications. The consumption information of this embodiment includes information regarding at least one energy-related parameter. The apparatus of this embodiment also includes means for determining aggregated consumption information, such as at least one of average consumption values or median consumption values, relating to use of the respective software applications by the plurality of users and means for causing the aggregated consumption information for the respective software applications to be provided.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE SEVERAL VIEWS OF THE DRAWINGS

Having thus described some embodiments of the invention in general terms, reference will now be made to the accompanying drawings, which are not necessarily drawn to scale, and wherein:

FIG. 1 illustrates a system for providing consumption information for a plurality of software applications in accordance with one embodiment of the present invention;

FIG. 2 is a schematic block diagram of one or more entities of a system of FIG. 1, including, for example, a database server, an application store server and a mobile terminal, in accordance with one embodiment of the present invention;

FIG. 3 is a flowchart of operations performed from the context of the application store server in accordance with one embodiment of the present invention;

FIG. 4 is a flowchart of operations performed from the context of the database server in accordance with one embodiment of the present invention;

FIG. 5 illustrates a system for providing consumption information for a plurality of software applications in accordance with one embodiment of the present invention; and

FIG. 6 is a signaling flow diagram illustrating the provision of consumption information for a plurality of software applications by a system as shown in FIG. 5 in accordance with one embodiment of the present invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

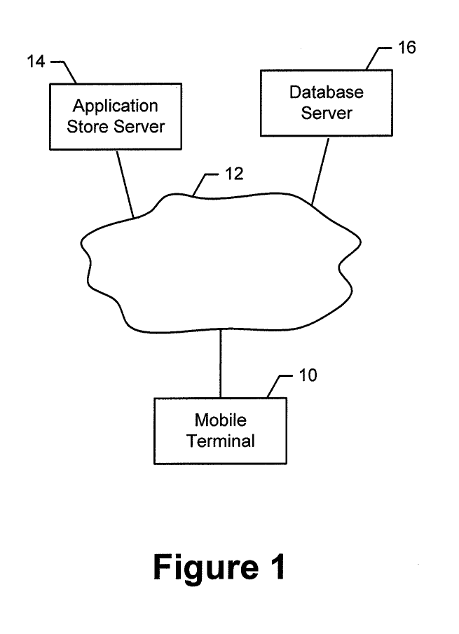

FIG. 1 illustrates a schematic representation of a system for providing consumption information for respective ones of a plurality of software applications according to some example embodiments of the present invention. It will be appreciated that the scope of the invention encompasses many potential embodiments in addition to those illustrated and described herein. As such, while FIG. 1 illustrates one example of a configuration of a system for providing consumption information in the context of an application store, numerous other configurations may also be used to implement embodiments of the present invention, such as configurations in the context of a social network, such as Facebook.

In at least some embodiments, the system includes one or more mobile terminals 10, also known as user equipment (UE), an application store server 12 and a database server 14, which are configured to communicate over a network 16. The network may comprise a wireline network, wireless network, or some combination thereof. The network may comprise a Public Land Mobile Network (PLMN) operated by a network operator. In this regard, the network may, for example, comprise an operator network providing cellular network access in accordance with Universal Terrestrial Radio Access Network (UTRAN) and/or Evolved-UTRAN (E-UTRAN) standards. The network may additionally or alternatively comprise the internet.

The mobile terminal 10 may comprise any computing device configured to access network services (e.g., cellular network services), such as may be provided by a network operator, such as an operator of at least a portion of the network 16. The mobile terminal may be configured to access the network through radio access that may be provided by a network access point or base station. The mobile terminal 10 may be embodied as a server, desktop computer, laptop computer, mobile terminal, mobile computer, mobile phone, mobile communication device, game device, digital camera/camcorder, audio/video player, television device, radio receiver, digital video recorder, positioning device, any combination thereof, and/or the like. Although described herein in the context of a mobile terminal, the method, apparatus and computer program product of some example embodiments may also support and work with one or more stationary devices that are capable of executing software applications and providing consumption information related thereto, either instead of or in addition to a mobile terminal. As such, reference to mobile terminal is by example and not by way of limitation.

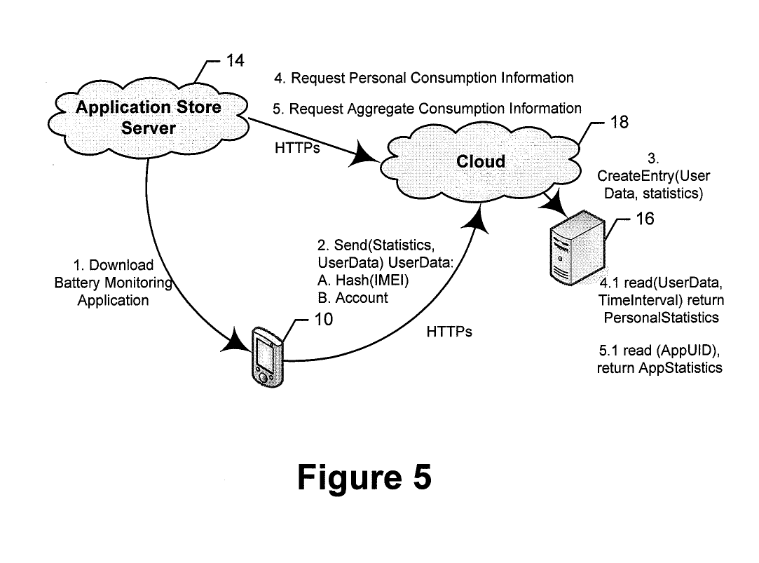

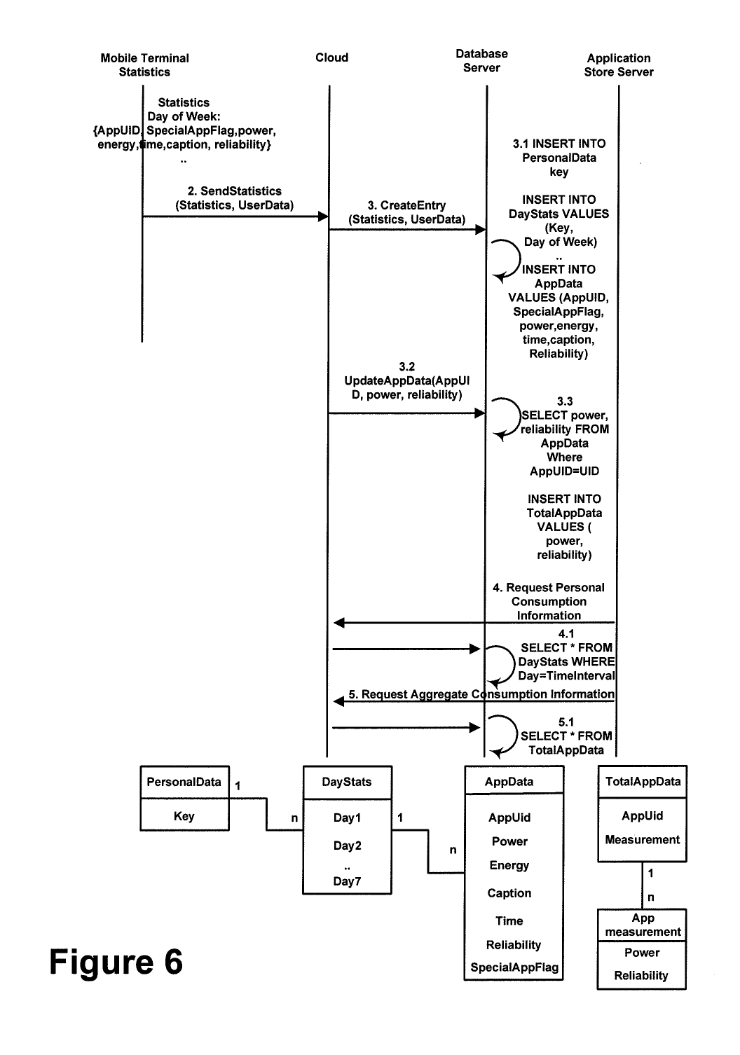

The application store server 12 may comprise a computing device that stores or otherwise has access to a plurality of different software applications that are offered to consumers, such as the user of the mobile terminal 10, for downloading across the network 16, such as in accordance with a license agreement. As described herein, the database server 14 may also comprise a computing device that stores and processes consumption information for a plurality of users and a plurality of software applications. The database server may be in communication with and responsive to both the mobile terminal and the application store server as described below. In one embodiment, such as described below in conjunction with FIGS. 5 and 6, the database server may be in communication with the network and, in turn, the mobile terminals via a cloud, such as a cloud computing platform. As defined by the National Institute of Standards and Technology, cloud computing is a model for providing convenient, on-demand network access to a shared pool of configurable computing resources, e.g., networks, servers, storage, applications and services, that can be rapidly provisioned and released with minimal management effort or service provider interaction. However the database server need not communicate via a cloud, but may communicate with the network in other manners. For example, the database server may be within an enterprise database environment. While the database server of the illustrated embodiment is shown to be distinct and independent from the application store server, the database server may be collocated with the application store server in another embodiment. For example, the application store server may include the database server in one embodiment.

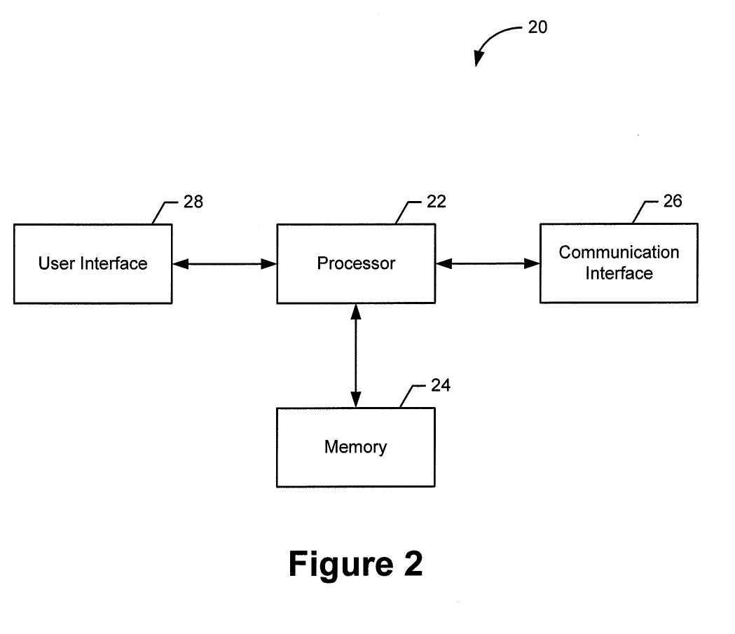

Referring to FIG. 2, an apparatus 20 that may be configured to function as a mobile terminal 10, an application store server 12 or a database server 14 is illustrated. The apparatus includes various means, such as a processor 22, memory 24, communication interface 26 and optionally a user interface 28, for performing the various functions herein described. These means of the apparatus as described herein may be embodied as, for example, hardware elements (e.g., a suitably programmed processor, combinational logic circuit, and/or the like), a computer program product comprising computer-readable program instructions (e.g., software or firmware) stored on a computer-readable medium (e.g. memory) that is executable by a suitably configured processing device (e.g., the processor), or some combination thereof.

The processor 22 may, for example, be embodied as various means including one or more microprocessors with accompanying digital signal processor(s), one or more processor(s) without an accompanying digital signal processor, one or more coprocessors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor comprises a plurality of processors. In an example embodiment, the processor is configured to execute instructions stored in the memory 24 or otherwise accessible to the processor. These instructions, when executed by the processor, may cause the apparatus to perform one or more of the functionalities of the mobile terminal 10, the application store server 12 or the database server 14 as described herein. As such, whether configured by hardware or software methods, or by a combination thereof, the processor may represent an entity configured to perform operations according to embodiments of the present invention when configured accordingly. Thus, for example, when the processor is embodied as an ASIC, FPGA or the like, the processor may comprise specifically configured hardware for conducting one or more operations described herein. Alternatively, as another example, when the processor is embodied as an executor of instructions, the instructions may specifically configure the processor to perform one or more algorithms and operations described herein.

The memory 24 may include, for example, volatile and/or non-volatile memory. Although illustrated in FIG. 2 as a single memory, the memory may comprise a plurality of memories. The memory may comprise volatile memory, non-volatile memory, or some combination thereof. In this regard, the memory may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory may be configured to store information, data, applications, instructions, or the like for enabling the mobile terminal to carry out various functions in accordance with some example embodiments of the present invention. For example, in at least some embodiments, the memory is configured to buffer input data for processing by the processor 22. Additionally or alternatively, in at least some embodiments, the memory is configured to store program instructions for execution by the processor. The memory may store information in the form of static and/or dynamic information.

The communication interface 26 may be embodied as any device or means embodied in hardware, a computer program product comprising computer readable program instructions stored on a computer readable medium (e.g., the memory 24) and executed by a processing device (e.g., the processor 22), or a combination thereof that is configured to receive and/or transmit data from/to a remote device over the network 18. In this regard, the communication interface may be configured to transceive data over a PLMN network (e.g., a cellular network implementing UTRAN and/or E-UTRAN standards) operated by a network operator. In at least one embodiment, the communication interface is at least partially embodied as or otherwise controlled by the processor. In this regard, the communication interface may be in communication with the processor, such as via a bus. The communication interface may include, for example, an antenna, a transmitter, a receiver, a transceiver and/or supporting hardware or software for enabling communications with other entities of the system. The communication interface may be configured to receive and/or transmit data using any protocol that may be used for communications between computing devices of the system. The communication interface may additionally be in communication with the memory and/or user interface 28, such as via a bus.

In the context of a mobile terminal 10, the user interface 28 may be in communication with the processor 22 to receive an indication of a user input and/or to provide an audible, visual, mechanical, or other output to a user. As such, the user interface may include, for example, a keyboard, a mouse, a joystick, a display, a touch screen display, a microphone, a speaker, and/or other input/output mechanisms. The user interface may be in communication with the memory 24 and/or communication interface 26, such as via a bus. It is noted that the apparatus need not include a user interface and, indeed, in the context of an application store server 12 or a database server 14, the user interface may be eliminated.

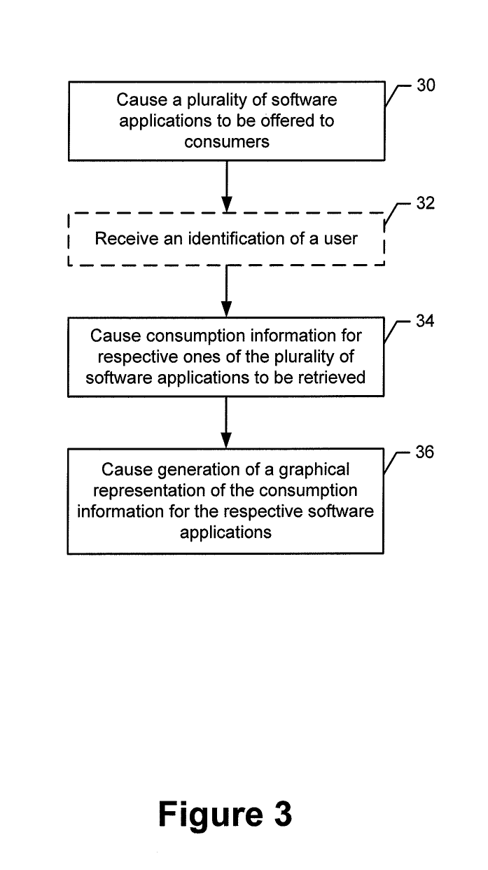

Referring now to FIG. 3, the operations performed by an apparatus 20 that comprises or is embodied as at least a portion of an application store server 12 are illustrated. As noted above, however, the apparatus may be comprised or be embodied as other types of servers, such as a server in a social network. However, the apparatus will be described hereinbelow in the context of an application store server for purposes of example, but not of limitation. As shown in block 30 of FIG. 3, the apparatus may include means, such as a processor 22 or the like, for causing a plurality of software applications to be offered for license, purchase, use, download or the like, to consumers. In this regard, the application store server may function as a platform that may be visited by various consumers who may review the plurality of software applications offered by the application store server and, in some instances, select one or more of the software applications for download to the mobile terminal 10 of the consumer, typically in exchange for a license fee or other payment. An application store server generally provides some information regarding the software applications that are offered to consumers. This information may include a description of the software applications, the operating requirements of the software applications, such as processing, memory and display requirements, and the like.

As shown in block 34 of FIG. 3, the apparatus 20 embodied by the application store server 12 may include means, such as the processor 22, the communication interface 26 and/or the like, for causing consumption information for respective ones of the plurality of software applications to be retrieved. While the consumption information may be retrieved from a memory 24 of the apparatus embodied as the application store server, the consumption information may be retrieved from a database server 14 as described below. As noted, the consumption information may be retrieved for each of a plurality of software applications. Additionally, while various consumption information may be retrieved, the consumption information may include information regarding energy-related parameter(s), such as current, voltage, power, energy, usage time and/or values determined based on one or more of the foregoing parameters. As described below, the consumption information that is retrieved may be aggregated consumption information based upon one or more energy-related parameters of the software application while executed by each of a plurality of users. Conversely, the consumption information that is retrieved may be personal or specific to a respective user of the software applications.

Based upon the consumption information, the apparatus 20 embodied by the application store server 12 may include means, such as the processor 22, the user interface 28 and/or the like, for causing generation of a graphical representation of the consumption information for the respective software applications. Accordingly, a consumer that is reviewing the software applications offered by the application store server may consider the consumption information for the respective software applications while considering whether to license a respective software application. In this regard, a consumer may select software applications for licensing based, at least in part, upon the consumption information for the respective software applications so as to ensure that these software application may be supported by the mobile terminal of the consumer in a manner that allows the battery of the mobile terminal to have a desired lifetime even while the software applications are executing. The graphical representation of the consumption information that is caused to be generated may have various forms, including bar graphs or other types of graphs to illustrate the consumption information of the various software applications. Alternatively, the graphical representation may include alphanumeric information either with or independent of a graph to define the consumption information for each of the plurality of software applications. Still further, other types of graphical representations of the consumption information may be provided in accordance with other example embodiments of the present invention.

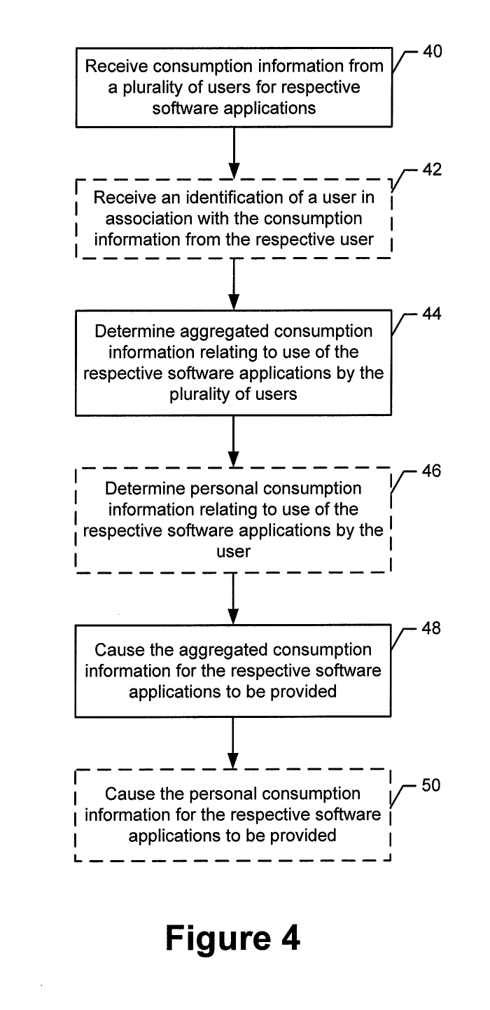

As described below, certain ones of the operations above may be modified or further amplified. Moreover, in some embodiments additional optional operations may also be included, as shown, for example in dashed lines in FIGS. 3 and 4. It should be appreciated that each of the modifications, optional additions or amplifications below may be included with the operations above either alone or in combination with any others among the features described herein. In one embodiment, the apparatus 20 embodied as the application store server 12 may optionally include means, such as the processor 22, the communication interface 26 and/or the like, for receiving an identification of a user. See block 32 of FIG. 3. While the user may be identified in various manners, the user of one embodiment is identified by a unique identifier associated with the mobile terminal 10 of a user, such as the international mobile equipment identity (IMEI) of the mobile terminal. Alternatively, the user could be identified based upon an account established by the user with the application store server. In this embodiment, the user may be uniquely identified by the account number previously established by the user with the application store server. In this embodiment, once the user has been identified, the consumption information that is provided, upon request by the user, may include personal consumption information relating to the use of the respective software applications by the user. As described below, the user may have previously provided consumption information to the database server 14 or the application store server. This personal consumption information may, in turn, be provided to the user upon request. In some embodiments, the personal consumption information may have been further processed, such as by the database server, in order to provide additional detail regarding the consumption information, such as by comparing the personal consumption information to average consumption levels or median consumption levels for the same software applications.

In addition to or instead of the provision of personal consumption information, the consumption information may be aggregated consumption information relating to the use of the respective software applications by a plurality of users. As also described below, each of a plurality of users may provide consumption information relating to their use of the respective software applications. This consumption information from the plurality of users may be aggregated by the database server 14 and one or more parameters relating to the consumption information, such as the average consumption and/or median consumption, may be determined for at least some of the software applications. The aggregated consumption information may be more generally available to consumers of the application store server 12 through generation of a graphical representation of the aggregated consumption information. Based upon this consumption information, such as the aggregated consumption information, the consumer may take into account the consumption information in determining the software applications to be downloaded.

As described in more detail below, the apparatus 20 that is embodied as the application store server 12 may cause consumption information to be received by receiving the consumption information through an application programming interface (API), such as an API with a database server 14 that has stored and processed the consumption information. In this embodiment, the generation of the graphical representation of the consumption information may include the processor 22 and/or the communication interface 26 rendering the consumption information on a graphical user interface, such as the user interface 28 of the mobile terminal 10. The consumption information that is received via the API may include a plurality of database records. As such, the rendering of the consumption information may include the rendering of consumption information according to the contents of the database records.

Referring now to FIG. 4, the operations performed by a database server 14 are illustrated. While the database server may be distinct and independent from the application store server 12 and may simply be in communication therewith via the network 16, the application store server and the database server may be co-located, and in one embodiment, the database server may be embodied by the application store server. Regardless of the implementation of the database server, the apparatus 20 that is embodied as the database server may include means, such as the processor 22, the communication interface 26 and/or the like, for receiving consumption information from a plurality of users for respective ones of the plurality of software applications. See block 40 of FIG. 4. As noted above, the consumption information may be provided in various forms including, for example, current, voltage, energy, power, usage time or values calculated based upon any one or more of the aforementioned parameters. The consumption information that is received from a plurality of users may identify the respective software applications, such as by a unique identifier (UID) assigned to and associated with a respective software application. In one optional embodiment shown in block 42 of FIG. 4, the apparatus may include means, such as the communication interface, the processor, and/or the like, for receiving an identification of the user in association with the consumption information provided by the mobile terminal 10 of the respective user. The user may be identified in various manners including, for example, by a unique identifier, such as the IMEI, associated with the mobile terminal of the user or an account number for an account that is previously established by the user with the application store server as described above. As such, the consumption information that is received may be associated with a respective application and optionally with a respective user.

As shown in block 44 of FIG. 4, the apparatus 20 embodied as the database server 14 may include means, such as a processor 22 or the like, for determining aggregated consumption information relating to use of the respective software applications by the plurality of users. In this regard, the apparatus, such as the processor, may separately determine aggregated consumption information for each of the software applications. The aggregated consumption information may have various forms but, in one embodiment, is the average consumption information and/or the median consumption information for a respective software application based upon the consumption information for the respective software application provided by the plurality of users. As such, the consumption information provided by the user may include not only the energy or power consumed by a respective software application, but also its time of use, current, voltage and/or other values calculated based upon the aforementioned parameters.

The apparatus 20 embodied as the database server 14 may also include means, such as the processor 22, the communication interface 26 or the like, for causing the aggregated consumption information for the respective software applications to be provided. See block 48 of FIG. 4. In one embodiment, the aggregated consumption information is caused to be provided in response to a request, such as a request from the application store server 12. In one embodiment, a communications interface is defined between the application store server and the database server by an API. The database server, such as the processor, the communication interface or the like, of this embodiment may receive a request for the aggregated consumption information from the application store server via the API. The database server may then provide the aggregated consumption information in response to the request, again via the API.

In addition to determining the aggregated consumption information, the apparatus 20 embodied as the database server 14 may also optionally include means, such as the processor 22 or the like, for determining personal consumption information relating to the use of the respective software applications by a particular user, such as a user uniquely identified by an IMEI, by an account with the application store server 12 or the like. See block 46 of FIG. 4. While based upon the consumption information provided by the user, the personal consumption information as determined by the apparatus embodied as the database server may provide additional information or level of detail. For example, the database server, such as the processor, may process the consumption information more efficiently or differently than the mobile terminal 10 of the user. Additionally, the personal consumption information may be determined on a relative basis with respect to the aggregated consumption information so that a user can determine whether the energy and/or power consumption of a respective application experienced by the mobile terminal of the user is consistent with or deviates from the aggregated consumption information for the same application. In this embodiment, the apparatus may also optionally include means, such as the processor, the communication interface 26 and/or the like, for causing the personal communication information for the respective software applications to be provided, such as to the application store server, the mobile terminal or the like. See block 50 of FIG. 4. In one embodiment, the personal consumption information is only provided to the mobile terminal of the user who provided the initial consumption information and not to other users since the personal consumption information may be specific to and private for the respective user.

Based upon the consumption information provided in accordance with some embodiments of the present invention, a consumer may review the consumption information of a number of the software applications offered by an application store server 12 and may at least partially base their selection of one or more software applications for downloading upon the consumption information so as to ensure that the software applications perform properly upon the mobile terminal 10 of the consumer and do not drain the battery of the mobile terminal in an unexpected manner. In another embodiment described above, the method and apparatus may provide personal consumption information that is tailored to the energy and/or power consumption and/or one or more other energy-related parameters of one or more software applications by a particular user so that the user may be more informed of the manner in which the software applications utilized by the user draw upon the battery resources of the mobile terminal.

In order to provide a further example of one embodiment of the method, apparatus and computer program product, reference is now made to FIGS. 5 and 6. In this embodiment, the mobile terminal 10 includes a battery monitoring application that is configured to monitor one or more energy-related parameters including, for example, the energy or power consumption of each of the applications executed by the mobile terminal. The mobile terminal may be initially provisioned with or otherwise have access to the battery monitoring application or a battery monitoring application may be downloaded, such as from the application store server 12, as shown as operation 1 in the embodiment of FIG. 5. The mobile terminal may then be utilized in a conventional fashion with the battery monitoring application collecting consumption information relating to the battery consumption attributable to execution of each of a plurality of different software applications. As noted above, each software application may be uniquely identified, such as by a UID. As such, the consumption information that is collected relating to the battery consumption attributable to a software application may be associated with the identification of the respective software application.

As shown in the lower portion of FIG. 6, the consumption information may have a predefined relational structure. In this regard, each user may have one or more different devices, such as a mobile terminal 10, a workstation, etc. The devices may each include a battery monitoring application which, in turn, monitors the battery consumption of the software applications executed by each device. In addition to associating the consumption information with the respective application, such as by the UID of the respective application, the consumption information may also be associated with the respective device, such as by associating the IMEI or other unique identifier of the device with the consumption information. Thus, the personal data shown in FIG. 6 may include a key or other unique identifier for each device of the user. While the consumption information collected by the battery monitoring application may be segregated based upon the respective application, the consumption information may be further partitioned by the mobile terminal and/or the database server 14 based upon, for example, the day of the week. In this regard, the mobile terminal, such as the processor 22, may be configured to provide statistical information, termed DayStats, that provides the application specific battery consumption information for each day of the week on a per software application and per device basis. Alternatively, the consumption information may be partitioned or organized in other fashions.

The mobile terminal may also provide consumption information, termed AppData, that is specific to a respective software application. Indeed, as shown by the 1:n relationship between the DayStats and the AppData, the DayStats may consist of a plurality of instances of AppData, albeit organized by day of the week. The AppData may include various types of consumption information, but, in one embodiment, includes the unique identifier, e.g., AppUid, of the application, the power consumed by the application, the energy consumed by the application, the time during which the application was executed, the reliability, a special flag, e.g., SpecialAppflag, and a caption. Reliability indicates the reliability of the measurement, while the caption is a short, textual description of the software application. In addition, the special flag is an indicator for special applications such as voice calls, which do not have a unique identifier.

Once the consumption information has been collected and organized by the mobile terminal 10, the mobile terminal may provide the consumption information, e.g., Statistics, to the database server 14, as shown in operation 2 of the embodiment of FIGS. 5 and 6. As shown in FIG. 5, the database server of one embodiment may communicate via a cloud 18. However, the database server is not dependent upon a cloud, but may, instead, operate in an enterprise database environment or other environments. As such, reference to the cloud is provided by way of example and not of limitation. In addition to providing the consumption information, the mobile terminal may provide an identifier that uniquely identifies the user and/or the mobile terminal. For example, the mobile terminal may provide a hashed representation of a unique identifier, such as the IMEI, of the terminal and/or an account previously established by the user with the application store server 12. In order to provide security for the transmission of the consumption information, the mobile terminal may communicate with the cloud via a secure connection, such as via a Hyper Text Transfer Protocol Secure (HTTPs) protocol. Upon receipt, the cloud 18 of this embodiment may create a database entry for the user and the mobile terminal 10 with the database server 14, as shown in operation 3 of FIGS. 5 and 6. In this regard, the database entry may be associated with the unique identification of the mobile terminal and/or the user. In one embodiment, the database server maintains a personal data structure that includes the unique identifiers of each of the devices that have contributed consumption information. Additionally, the database server may include other data structures to store the DayStats and the AppData that may be populated with the consumption information provided by the mobile terminal. See operation 3.1 of FIG. 6. Based upon the consumption information, such as the AppData, provided by each of the devices, the database server may maintain a total application data structure, termed TotalAppData in the embodiment of FIG. 6, which aggregates the consumption information for a respective application based upon the consumption information provided by a plurality of devices. As a result of the aggregation, the TotalAppData may provide a statistically significant estimation of the power consumed per usage time of a respective application. As the TotalAppData is an aggregate of the consumption information provided by a plurality of mobile terminals, the TotalAppData no longer is associated with the unique identifier of the device that contributed the consumption information, but is associated with a unique identifier, e.g., AppUid, of the respective software application. In addition to the unique identifier, the TotalAppData may include measurement information which, in turn, may be comprised of a collection of Appmeasurement data structures, each of which provides consumption information for the respective software application, albeit from a different device or at least a different period of execution. The database server may repeatedly update the TotalAppData, such as on a continuous, a periodic or other repeated basis. As shown in FIG. 6, for example, the database server may receive additional consumption information, such as AppData from the cloud 18, in operation 3.2 and may, in turn, update the TotalAppData as shown in operation 3.3

As noted above, the consumption information may be alternatively presented in a manner personal to a user or on an aggregated basis. In an embodiment in which a user desires to view the user's personal consumption information, the user may issue a request to the application store server 12 (or to the database server 14 in another embodiment) to view the personal consumption information of the user. In this regard, the user may be identified by an account number previously established with the application store server or with the unique identifier, such as the IMEI, associated with the mobile terminal 10 or other device of the user. The application store server may then issue a request in operation 4 of FIGS. 5 and 6 to the database server, such as via the cloud 18, for the personal consumption information. In order to maintain the security of the personal consumption information, the application store server and the cloud may communicate via a secure connection, such as via HTTPs protocol. The database server may then fetch the personal consumption information and provide the personal consumption information via the cloud to the application store server for display to the user, such as via a graphical representation of the personal consumption information presented via a browser. See operation 4.1 of FIGS. 5 and 6. In addition to the personal consumption information, the information displayed to the user may include the relevant time interval for the personal consumption information. The user may further query the application store server and, in turn, the database server to obtain personal consumption information for specific day(s) of the week.

Additionally or alternatively, aggregate consumption information may be requested for one or more specific software applications, such as for each software application offered by the application store server 10. In this regard, the application store server may issue a request that is routed via the cloud 18 to the database server 14 for aggregate consumption information, such as the TotalAppData, for one or more software applications identified, for example, identified by a unique identifier associated with the software application, such as a UID. See operation 5 of FIGS. 5 and 6. In response to the request, the database server may fetch and then provide the requested aggregate consumption information that may, in turn, be displayed, such as via a graphical representation presented by a browser, for example, to one or more consumers of the application store server. See operation 5.1 of FIGS. 5 and 6. The application store server and/or the consumers may, in turn, request additional aggregate consumption information, such as aggregate consumption information based upon day of the week or the like, which may, in turn, be provided by the database server.

Based upon the personal consumption information, a user may be able to develop an improved understanding of the manner in which the various software applications drain the battery resources of the mobile terminal 10 which may, in turn, affect future user behavior. Additionally, the aggregate consumption information may be reviewed by consumers relative to software applications offered by the application store server 12. As such, these consumers may take into account the aggregate consumption information in determining which of the software applications to download.

FIGS. 3 and 4 are flowcharts of a system, method, and computer program product according to exemplary embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the operations described herein may be embodied by computer program instructions of a computer program product. In this regard, the computer program product(s) which embody the operations described herein may be stored by one or more memory devices of a mobile terminal 10, an application store server 12, a database server 14, or the like and executed by a processor 22 in the respective device. In some embodiments, the computer program instructions comprising the computer program product(s) which embody the operations described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor 22 may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. For example, although described herein in the context of a mobile terminal, the method, apparatus and computer program product of some example embodiments may also interact with one or more stationary devices that are capable of executing software applications and providing consumption information related thereto, either instead of or in addition to a mobile terminal. As noted above, while described above in the context of an application store server 12 and a cloud computing platform, the method, apparatus and computer program product of some example embodiments may be employed in other environments including, for example, an environment that relies upon a social networking server instead of an application store server and/or an environment in which the database server 16 is within an enterprise database environment. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
causing a plurality of software applications to be offered to consumers;
causing consumption information for respective ones of the plurality of software applications to be retrieved, wherein the consumption information comprises information regarding at least one energy-related parameter; and
causing generation, with a processor, of a graphical representation of the consumption information for the respective software applications.

2. A method according to claim 1 further comprising receiving an identification of a user, wherein causing consumption information to be retrieved comprises causing personal consumption information relating to use of the respective software applications by the user to be retrieved.

3. A method according to claim 1 wherein causing consumption information to be retrieved comprises causing aggregated consumption information relating to use of the respective software applications by a plurality of users to be retrieved.

4. A method according to claim 1 wherein causing consumption information to be retrieved comprises receiving the consumption information through an application programming interface (API), and wherein causing generation of the graphical representation of the consumption information comprises rendering the consumption information on a graphical user interface.

5. A method according to claim 4 wherein receiving the consumption information comprises receiving a plurality of database records through the API, and wherein rendering the consumption information comprises rendering the consumption information according to content within the database records.

6. An apparatus comprising at least one processor and at least one memory including computer program code, the at least one memory and the computer program code configured to, with the at least one processor, cause the apparatus to at least:
cause a plurality of software applications to be offered to consumers;
cause consumption information for respective ones of the plurality of software applications to be retrieved, wherein the consumption information comprises information regarding at least one energy-related parameter; and
cause generation of a graphical representation of the consumption information for the respective software applications.

7. An apparatus according to claim 6 wherein the at least one memory and the computer program code are further configured to, with the at least one processor, cause the apparatus to receive an identification of a user, wherein the at least one memory and the computer program code are configured to, with the at least one processor, cause the apparatus to cause consumption information to be retrieved by causing personal consumption information relating to use of the respective software applications by the user to be retrieved.

8. An apparatus according to claim 6 wherein the at least one memory and the computer program code are configured to, with the at least one processor, cause the apparatus to cause consumption information to be retrieved by causing aggregated consumption information relating to use of the respective software applications by a plurality of users to be retrieved.

9. An apparatus according to claim 6 wherein the at least one memory and the computer program code are configured to, with the at least one processor, cause the apparatus to cause consumption information to be retrieved by receiving the consumption information through an application programming interface (API), and wherein the at least one memory and the computer program code are configured to, with the at least one processor, cause the apparatus to cause generation of the graphical representation of the consumption information by rendering the consumption information on a graphical user interface.

10. An apparatus according to claim 9 wherein the at least one memory and the computer program code are configured to, with the at least one processor, cause the apparatus to receive the consumption information by receiving a plurality of database records through the API, and wherein the at least one memory and the computer program code are configured to, with the at least one processor, cause the apparatus to render the consumption information by rendering the consumption information according to content within the database records.

11. A method comprising:
receiving consumption information from a plurality of users for respective ones of a plurality of software applications, wherein the consumption information comprises information regarding at least one energy-related parameter;
determining, with a processor, aggregated consumption information relating to use of the respective software applications by the plurality of users; and
causing the aggregated consumption information for the respective software applications to be provided.

12. A method according to claim 11 wherein determining aggregated consumption information comprises determining at least one of average consumption values or median consumption values relating to use of the respective software applications by the plurality of users.

13. A method according to claim 11 further comprising receiving a request for the aggregated consumption information through an application programming interface (API), wherein causing the aggregated consumption information to be provided comprises causing the aggregated consumption information to be provided in response to the request.

14. A method according to claim 11 further comprising:
receiving an identification of a user in association with the consumption information from the respective user;
determining personal consumption information relating to use of the respective software applications by the user; and
causing the personal consumption information for the respective software applications to be provided.

15. A method according to claim 14 further comprising receiving a request for the personal consumption information through an application programming interface (API), wherein the request includes the identification of the user, and wherein causing the personal consumption information to be provided comprises causing the personal consumption information to be provided in response to the request.

16. An apparatus comprising at least one processor and at least one memory including computer program code, the at least one memory and the computer program code configured to, with the at least one processor, cause the apparatus to at least:
receive consumption information from a plurality of users for respective ones of a plurality of software applications, wherein the consumption information comprises information regarding at least one energy-related parameter;
determine aggregated consumption information relating to use of the respective software applications by the plurality of users; and
cause the aggregated consumption information for the respective software applications to be provided.

17. An apparatus according to claim 16 wherein the at least one memory and the computer program code are configured to, with the at least one processor, cause the apparatus to determine aggregated consumption information by determining at least one of average consumption values or median consumption values relating to use of the respective software applications by the plurality of users.

18. An apparatus according to claim 16 wherein the at least one memory and the computer program code are further configured to, with the at least one processor, cause the apparatus to receive a request for the aggregated consumption information through an application programming interface (API), wherein the at least one memory and the computer program code are configured to, with the at least one processor, cause the apparatus to cause the aggregated consumption information to be provided by causing the aggregated consumption information to be provided in response to the request.

19. An apparatus according to claim 16 wherein the at least one memory and the computer program code are further configured to, with the at least one processor, cause the apparatus to:
receive an identification of a user in association with the consumption information from the respective user;
determine personal consumption information relating to use of the respective software applications by the user; and
cause the personal consumption information for the respective software applications to be provided.

20. An apparatus according to claim 19 wherein the at least one memory and the computer program code are further configured to, with the at least one processor, cause the apparatus to receive a request for the personal consumption information through an application programming interface (API), wherein the request includes the identification of the user, and wherein the at least one memory and the computer program code are configured to, with the at least one processor, cause the apparatus to cause the personal consumption information to be provided by causing the personal consumption information to be provided in response to the request.
